(19) United States
(12) Patent Application Publication
(10) Pub. No.: US 2015/0250313 A1
(43) Pub. Date: Sep. 10, 2015

(54) ADJUSTMENT APPARATUS

(71) Applicant: Giancarlo AGRESTA, Hertfordshire (GB)

(72) Inventor: Giancarlo Agresta, Hertfordshire (GB)

(21) Appl. No.: 14/439,534

(22) PCT Filed: Oct. 30, 2013
(86) PCT No.: PCT/GB13/52827

§ 371 Date: Apr. 29, 2015

(30) Foreign Application Priority Data
Oct. 30, 2012 (GB) 1219530.1

(51) Int. Cl. A47B 95/00; F16H 25/20; F16H 25/18

(52) U.S. Cl. CPC A47B 95/008; F16H 25/18; F16H 25/20

(57) ABSTRACT

An adjustment apparatus for providing adjustment of position and/or orientation of a piece of furniture relative to a surface near or against which the piece of furniture is to be placed, wherein the apparatus includes: a first member capable of being rotated; and a second member capable of longitudinal movement.

The present invention relates to adjustment apparatus, in particular, adjustment apparatus for providing adjustment of position and/or orientation of a piece of furniture relative to a surface near or against which said piece of furniture is to be placed. The invention also relates to a piece of furniture including adjustment apparatus, a kit for assembly into adjustment apparatus, a method of assembling a piece of furniture including adjustment apparatus, and use of adjustment apparatus in furniture.

Adjustment apparatus are known in the art for use with pieces of furniture. Typically, such adjustment apparatus are used in a foot of the piece of furniture and adjust the relative height of a respective corner of the piece of furniture. Such adjustable feet may, in a simple arrangement, comprises two respective parts, both provided with correspondingly shaped screw threads for engagement and adjustment of the relative height or length of the foot by simply rotating one part whilst the other part remains stationary. These adjustable feet may be manufactured at low cost in plastics materials. More advanced and stronger adjustable feet are also known which are manufactured from metal and have an outer sleeve which protects and holds parts of the adjustment device together. These advanced adjustable feet have two inner members which are engaged through respective screw threads. One of the members can rotate and the other moves along the rotating member to change the overall length (and therefore the height) of the foot. The member which rotates is acted upon by a mechanism which converts a rotational input (from a screwdriver or otherwise) at approximately a right-angle to the axis of the member into a rotation of the member around its axis. Therefore, at least three parts are required to convert the rotational input into a longitudinal extension of the foot. The sleeve acts to ensure engagement of the mechanism and the members, and provides strength for heavy-duty use. Therefore, without the sleeve this foot cannot operate. Further, as these adjustable feet are made from metal and have a number of moving parts, they are more complex to manufacture and, therefore, more costly.

In the field of assembly of kitchens, it is known to use adjustable feet on kitchen cabinets and the like. However, there is presently no way of easily lining up a number of independently movable cabinets next to each other with respect to an upright surface in a speedy and efficient manner. The problem is at least in part provided by the unevenness of practically all upright surfaces—for example a wall in a kitchen—which, until a row of cabinets is placed in the vicinity of the wall, it may not be apparent how uneven is the surface of the wall. To date, the only method at the disposal of a fitter is to pack behind each of the cabinets so as to make the fronts thereof even. The packing used is typically any surplice material from the kitchen install, for example spare parts of cabinets and packaging material. However, beyond being placed behind the cabinet, nothing holds that packing material in place and inevitably, as there are a number of cabinets in the row, it takes some time to line up all cabinets and movement of other cabinets whilst packing the present one occurs. Further, after fitting and filling with contents, the cabinets have a greater tendency to move and change their position and, typically, cabinets having packing behind them become less stable, leading to wobbling and/or becoming misaligned.

As such, the present invention is aimed at providing adjustment apparatus without the disadvantages associated with known apparatus and preferably which provide a more effective and efficient way of levelling fronts of cabinets with respect to an upright surface.

According to a first aspect, the present invention provides an adjustment apparatus, for providing adjustment of position and/or orientation of a piece of furniture relative to a surface near or against which said piece of furniture is to be placed, wherein the apparatus comprises:

a first member, capable of being rotated; and

a second member, capable of longitudinal movement,

wherein the first and second members are each mountable in said furniture and so guidable in their movement, the first member acts upon the second member to provide longitudinal movement thereof and the second member is arranged to act upon said surface which, in use, is capable of providing adjustment of position and/or orientation of said piece of furniture with respect to said surface.

Preferably, the first member acts directly upon the second member.

Preferably, the adjustment apparatus consists of the first and second members. However, other components which do not perform adjustment may be provided.

Preferably, the first and second members comprises corresponding portions for touch-engagement therebetween without locking engagement therebetween. An example of touch-engagement without locking engagement is two members which can co-operate together but which are not permanently connected. They may well be held in register together, but are not locked to each other—unlike with a screw thread (locking) engagement,

Preferably, the first and second members are arranged to co-operate such that an axis of rotation of the first member is transverse an axis of movement of the second member. Alternatively, the first and second members are arranged to co-operate such that an axis of rotation of the first member is the same as an axis of movement of the second member.

Preferably, the first and second members are each locatable within an aperture formable in said furniture. Preferably, the first and second members are locatable in an external support of a piece of furniture with support for the first and second members provided by said piece of furniture. Preferably, support for the first and second member is provided without an external sleeve surrounding the first and second member. Preferably, at least one of the first and second members are locatable in a side wall of said furniture and, preferably both are locatable in the side wall thereof. Preferably, the adjustment apparatus is locatable within two converging openings made in said piece of furniture. Preferably, the axes of the openings converge. Preferably, the converging openings are circular and, preferably have axes transverse each other. Preferably, the adjustment apparatus is locatable in an external support of a piece of furniture and the apparatus is adjustable from an inside surface of the external support. Most preferably, the adjustment apparatus is locatable in a side-wall of the piece of furniture, a top surface or a bottom surface.

Preferably, the adjustment apparatus comprises a stopper or ratchet, preventing return movement of the second member. Preferably, the second member comprises on a distal end capable of contacting said upright surface a pad or buffer for preventing damage to said surface. Preferably, the second member comprises an extension member. Most preferably, either end or both ends of the second member comprise an extension member. Preferably, the extension member or the second member is arranged so as to enable securing the extension member or the second member to a wall fixing. When mounted in furniture, at least a part of the first and second member are mounted in the furniture.

Preferably, the first member comprises a spiral-shaped groove and the second member comprises a plurality of protrusions which are capable of interacting with the spiral-shaped groove. Preferably, the spiral-shaped groove is an endless spiral. Preferably, the spiral-shaped groove comprises at least one full rotation and preferably about two. Preferably, the groove is provided by a raised wall from a surface of the first member. Preferably, the raised wall and/or the groove stop short of a centre of the first member. Preferably, the second member comprises a plurality of alternating grooves and protrusions which are oriented in a direction transverse an axis of movement of the second member.

Preferably, the first member comprises a spiral-shaped groove and the second member comprises a protrusion which interacts with the groove to move the second member longitudinally. Preferably, the apparatus comprises more than one groove on the first member and/or more than one protrusion on the second member. Preferably, the first member comprises, on an opposite side to the spiral groove, means for rotating the first member. Preferably, the means for rotating is a handle, or a slot or cruciform cut-out for receipt of a screwdriver head, coin or the like. Preferably, the axis of rotation of the first member is transverse the longitudinal movement of the second member. Preferably, the axis of rotation of the first member is substantially at a right-angle to the longitudinal movement of the second member.

Preferably, the first member comprises a peripheral edge which frictionally engages the second member. Preferably, the first member comprises one or more teeth for interacting with one or more transverse grooves provided on the second member. Preferably, the first member comprises one or more teeth for interacting with a screw thread provided on the second member. Preferably, the teeth are located around at least part of a periphery of the first member. Preferably, the teeth are located around a circumference of the first member. Preferably, the first member comprises means for rotating the first member. Preferably, the means for rotating is a handle, or a slot or cruciform cut-out for receipt of a screwdriver head, coin or the like. Preferably, the second member comprises transverse grooves or a screw thread along a majority of its length.

Preferably, the first member comprises an aperture through which the second member can move. Preferably, the aperture of the first member comprises a screw thread and a surface of the second member comprises a correspondingly-shaped surface. Preferably, the first member is provided with a grooved outer surface.

Preferably, the second member comprises a screw thread along a majority of its length. Preferably, the adjustment apparatus further comprises a locking device comprising a flanged spindle for receipt of the first member and locking means for tightening or clamping the first member therebetween. Most preferably, the spindle comprises a tab for contacting said furniture.

According to a further aspect, the present invention provides a piece of furniture comprising an adjustment apparatus, for providing adjustment of position and/or orientation of the furniture relative to a surface near or against which the furniture is to be placed, the apparatus being mounted in an aperture of the furniture, wherein the apparatus comprises:

a first member, capable of being rotated in the aperture; and

a second member, at least part thereof capable of longitudinal movement in the aperture,

wherein the first member acts upon the second member to provide longitudinal movement thereof and the second member is arranged to act upon said surface which, in use, is capable of providing adjustment of position and/or orientation of said piece of furniture with respect to said surface.

Preferably, for floor mounted furniture, two adjustment apparatuses are provided, one in each upper surface-facing corner thereof and, preferably two further adjustment apparatuses are provided, one in each lower surface-facing corner thereof. Preferably, for wall mounted furniture, two adjustment apparatuses are provided, one in each lower surface-facing corner thereof. Preferably, the piece of furniture comprises an adjustment apparatus comprising any one or more of the features described in relation to the first aspect of the invention.

According to a further aspect, the present invention provides a kit for assembly into an item of furniture including an adjustment apparatus, the apparatus for adjusting position and/or orientation of a piece of furniture relative to a surface near or against which said piece of furniture is to be placed, the kit comprising:

an item of furniture for assembly;

a first member, capable of being mounted in an aperture of the furniture and rotated therein; and

a second member, capable of being mounted in an or the aperture of the furniture and capable of longitudinal movement therein,

wherein the first member acts upon the second member to provide longitudinal movement thereof and the second member is arranged to act upon said surface which, in use, is capable of providing adjustment of position and/or orientation of said piece of furniture with respect to said surface.

Preferably, the kit comprises an adjustment apparatus comprising any one or more of the features described in relation to the first aspect of the invention.

In a yet further aspect, the present invention provides a method for assembling a piece of furniture comprising an adjustment apparatus, the method comprising:

providing an aperture in a part of a piece of furniture to which the adjustment

apparatus is to be added; and

mounting the adjustment apparatus in the aperture, the adjustment apparatus comprising:
a first member, capable of being rotated in the aperture; and
a second member, at least part thereof capable of longitudinal movement in the aperture,
   wherein the first member acts upon the second member to provide longitudinal movement thereof and the second member is arranged to act upon said surface which, in use, is capable of providing adjustment of position and/or orientation of the furniture with respect to said surface.

Preferably, one or more apertures are provided in the furniture into which a part or parts of the adjustment apparatus may be placed. Preferably, two converging apertures are provided in the furniture. Preferably, the first member is located into its aperture prior to the second member being located into its aperture, the first and second members subsequently being brought into engagement. Preferably, the second member is located into its aperture prior to the first member being located into its aperture, the first and second members subsequently being brought into engagement. Preferably, the first member is partially rotated to ensure engagement of the first and second members. Preferably, providing for floor mounted furniture two adjustment apparatuses, one in each upper surface-facing corner thereof and, preferably two further adjustment apparatuses, one in each lower surface-facing corner thereof. Preferably, providing for wall mounted furniture two adjustment apparatuses, one in each lower surface-facing corner thereof. Preferably, the method comprises providing an adjustment apparatus comprising any one or more of the features described in relation to the first aspect of the invention.

According to a yet further aspect, the present invention provides a use of an adjustment apparatus mounted in an aperture of a piece of furniture, for providing adjustment of position and/or orientation of a piece of furniture relative to a surface near or against which said piece of furniture is to be placed, wherein the apparatus comprises:

a first member, capable of being rotated in the aperture; and

a second member, at least part thereof capable of longitudinal movement in the aperture,

wherein the first member acts upon the second member to provide longitudinal movement thereof and the second member is arranged to act upon said surface, such that rotation of the first member causes longitudinal movement of the second member which provides adjustment of position and/or orientation of the furniture with respect to said surface.

Preferably, the use comprises use of an adjustment apparatus comprising any one or more of the features described in relation to the first aspect of the invention.

According to a further aspect of the present invention, there is provided a use of an adjustment apparatus, for providing adjustment of position and/or orientation of a piece of furniture relative to an upright surface near or against which said piece of furniture is to be placed, wherein, for floor mounted furniture, the adjustment apparatus is located in an upper surface-facing corner to act upon said upright surface, or wherein, for wall mounted furniture, the adjustment apparatus is located in a lower surface-facing corner to act upon said upright surface.

According to a yet further aspect, the present invention provides an adjustment apparatus, for providing adjustment of position and/or orientation of a piece of furniture relative to an upright surface near or against which said piece of furniture is to be placed, wherein the apparatus comprises:

a first member, capable of being rotated; and

a second member, capable of longitudinal movement,

wherein the first and second members are locatable within said furniture and are arranged to act upon said upright surface, the first member acts upon the second member to provide longitudinal movement thereof which, in use, is capable of providing adjustment of position and/or orientation of said piece of furniture with respect to said upright surface.

According to a yet further aspect, the present invention provides a piece of furniture comprising an adjustment apparatus, for providing adjustment of position and/or orientation of the furniture relative to an upright surface near or against which the furniture is to be placed, wherein the apparatus comprises:

a first member, capable of being rotated; and

a second member, capable of longitudinal movement,

wherein the first and second members are locatable within the furniture and are arranged to act upon said upright surface, the first member acts upon the second member to provide longitudinal movement thereof which, in use, is capable of providing adjustment of position and/or orientation of said piece of furniture with respect to said upright surface.

According to a yet further aspect, the present invention provides a kit for assembly into an adjustment apparatus for adjusting position and/or orientation of a piece of furniture relative to an upright surface near or against which said piece of furniture is to be placed, the kit comprising:

a first member, capable of being rotated; and

a second member, capable of longitudinal movement,

wherein the first and second members are locatable within said furniture and are arranged to act upon said upright surface, the first member acts upon the second member to provide longitudinal movement thereof which, in use, is capable of providing adjustment of position and/or orientation of said piece of furniture with respect to said upright surface.

In a yet further aspect, the present invention provides a method for assembling a piece of furniture comprising an adjustment apparatus, the method comprising:

providing a part of a piece of furniture to which the adjustment apparatus is to be added; and

providing an adjustment apparatus comprising:
a first member, capable of being rotated; and
a second member, capable of longitudinal movement,
   wherein the first and second members are located within said furniture and are arranged to act upon an upright surface, the first member acts upon the second member to provide longitudinal movement thereof which, in use, is capable of providing adjustment of position and/or orientation of the furniture with respect to said upright surface.

According to a yet further aspect, the present invention provides a use of an adjustment apparatus, for providing adjustment of position and/or orientation of a piece of furniture relative to an upright surface near or against which said piece of furniture is to be placed, wherein the apparatus comprises:

a first member, capable of being rotated; and

a second member, capable of longitudinal movement,

wherein the first and second members are locatable within said furniture and are arranged to act upon said upright surface, the first member acts upon the second member to provide longitudinal movement thereof which, in use, is capable of providing adjustment of position and/or orientation of said piece of furniture with respect to said upright surface.

Advantageously, the adjustment apparatuses provide a stabiliser, which has a stabilising effect upon the furniture the apparatus is applied to. Further, the adjustment apparatuses provide in use adjustment of position and/or orientation of a piece of furniture relative to a surface near or against which the furniture is to be placed. Adjustment is easily undertaken, as they are easy to use, involving only simple tools. Fine adjustment is possible. Adjustment is undertaken from within a kitchen cabinet and, therefore, adjacent articles do not prevent adjustment. The adjustment apparatuses are discreet. Only a first member which rotates is visible once installed. Providing a first member which is capable of rotation and a second member which moves longitudinally following rotation of the first member allows easy and accurate adjustment. Further, when the first member acts directly upon the second member, a simplified operation is provided, involving only two moving parts, especially when the adjustment apparatus consists of only two moving parts. Further, no sleeve or housing is required to hold components in register, as the aperture fulfils this role. The aperture receives and supports the components. Further, the aperture guides their movement. A first member is guided and may rotate within the aperture. A second member is guided and may move longitudinally within the aperture. The aperture also serves to constrain unwanted movement, whilst allowing desired movement of the first member. Further advantageously, fewer components are required, which reduces raw material costs. In particular, the apparatuses are light and/or have fewer moving parts. Further advantageously, furniture is stabilised in situ and provides a more professional and pleasing finish to the furniture, especially when the furniture is a row of cabinets. The furniture matches better with additional components, for example a cornice or shelves, providing properly aligned furniture which is pleasing to the eye. The stabilising effect achieved is longer-lasting because, for example, when the weight of the contents is placed within the furniture/cabinet(s), substantially no movement of the position and/or orientation occurs. Further, following prolonged use, furniture is still stabilised and held in the correct position. Additionally, as furniture is properly aligned, the lifespan of components, for example hinges, is increased through reducing adverse wear and tear.

The invention will now be disclosed, by way of example only, with reference to the following drawings, in which:

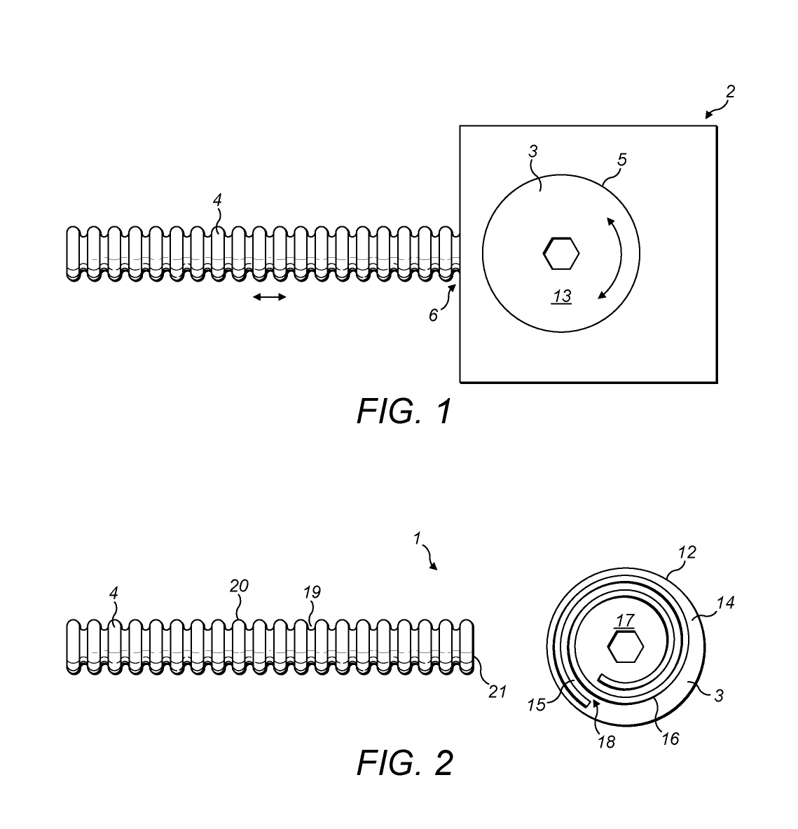

FIG. 1 is a plan view of a first adjustment apparatus;

FIG. 2 is a plan view of the first adjustment apparatus in disassembled form;

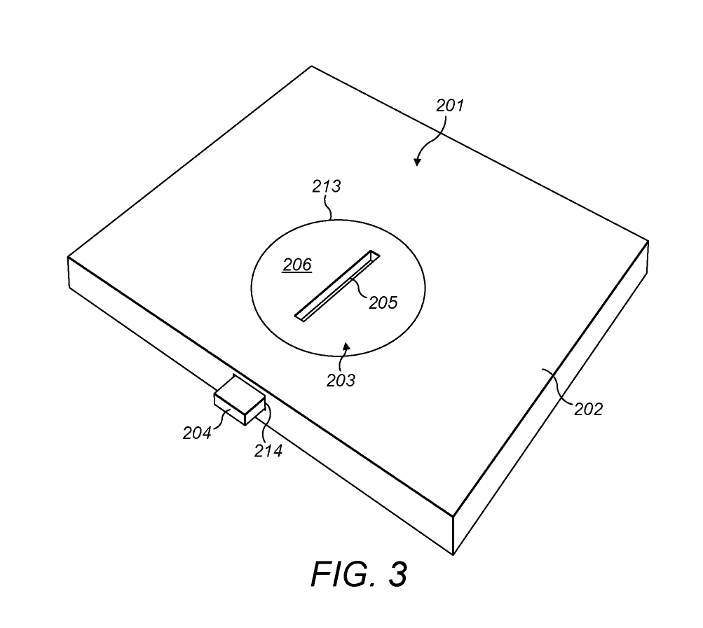

FIG. 3 is a perspective view of a second adjustment apparatus;

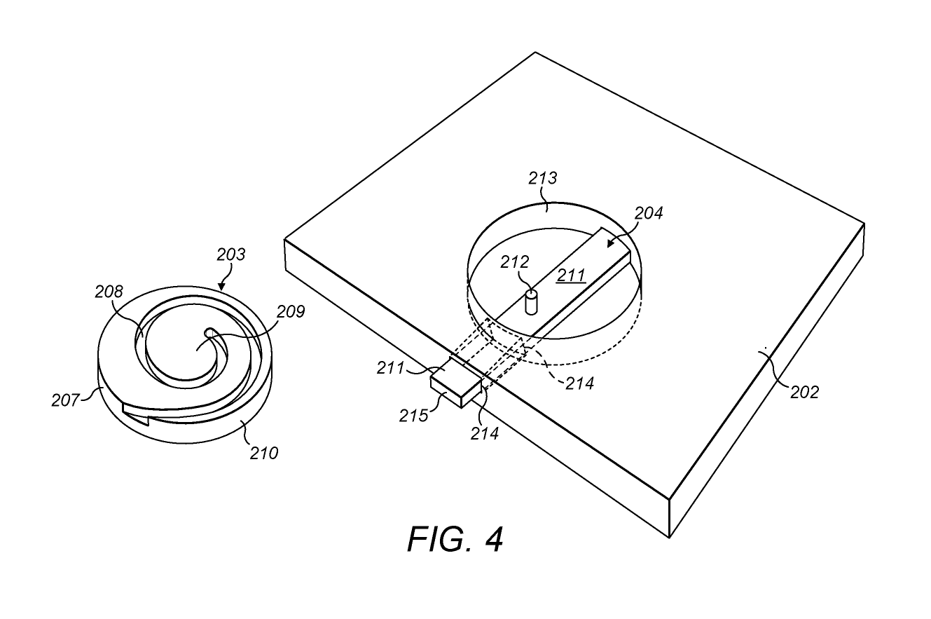

FIG. 4 is a perspective view of the second adjustment apparatus in part disassembled form;

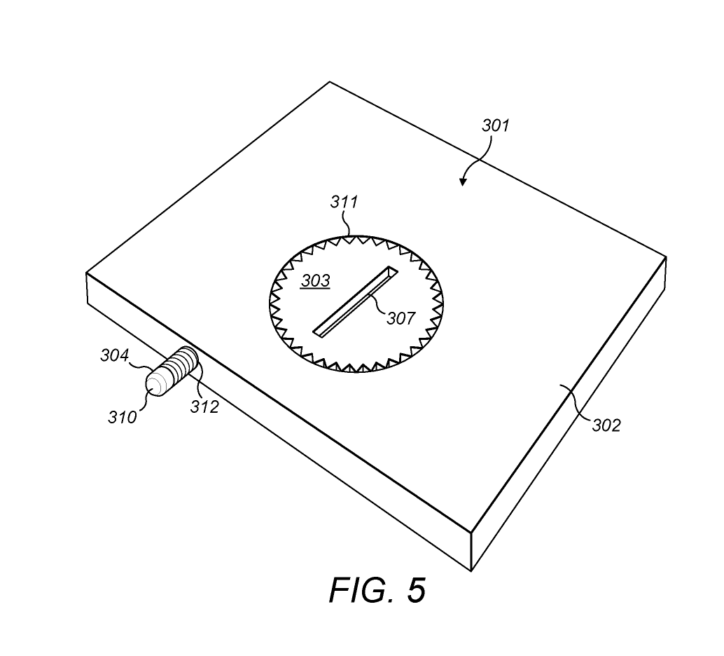

FIG. 5 is a perspective view of a third adjustment apparatus;

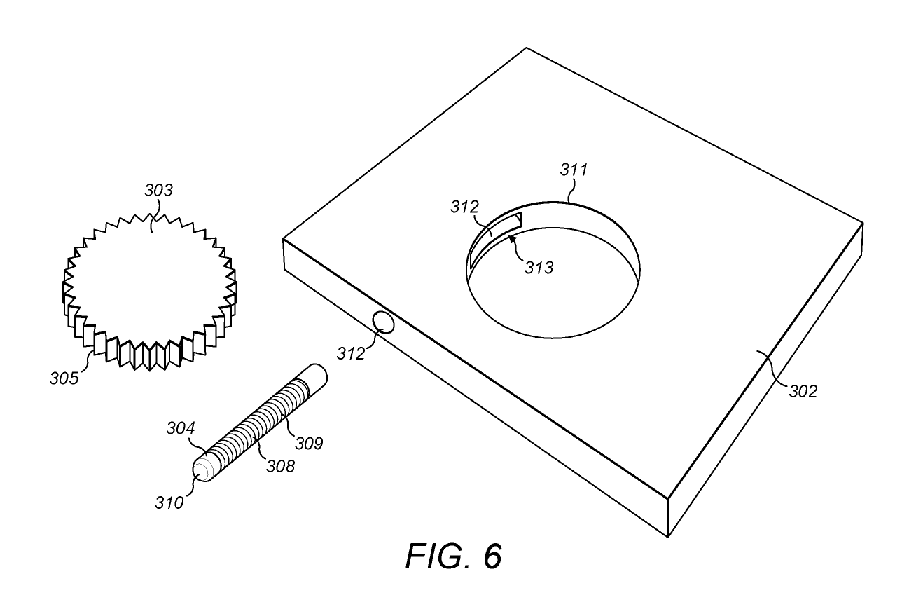

FIG. 6 is a perspective view of the third adjustment apparatus in disassembled form;

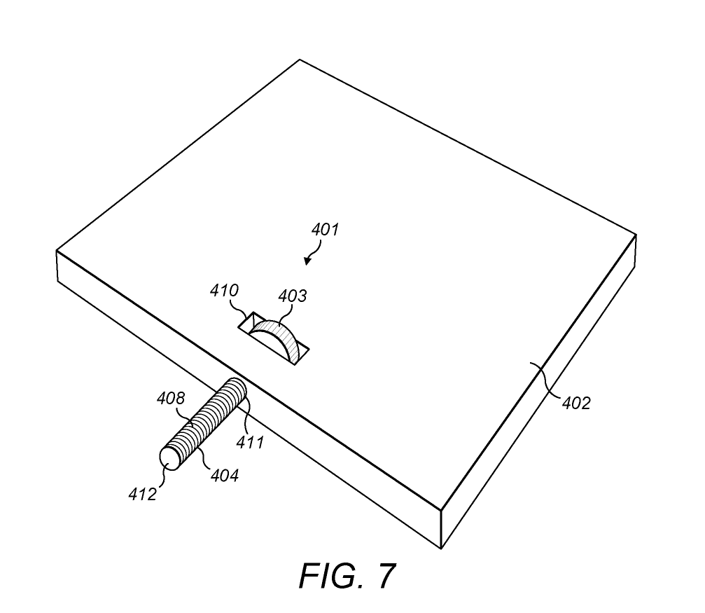

FIG. 7 is a perspective view of a fourth adjustment apparatus;

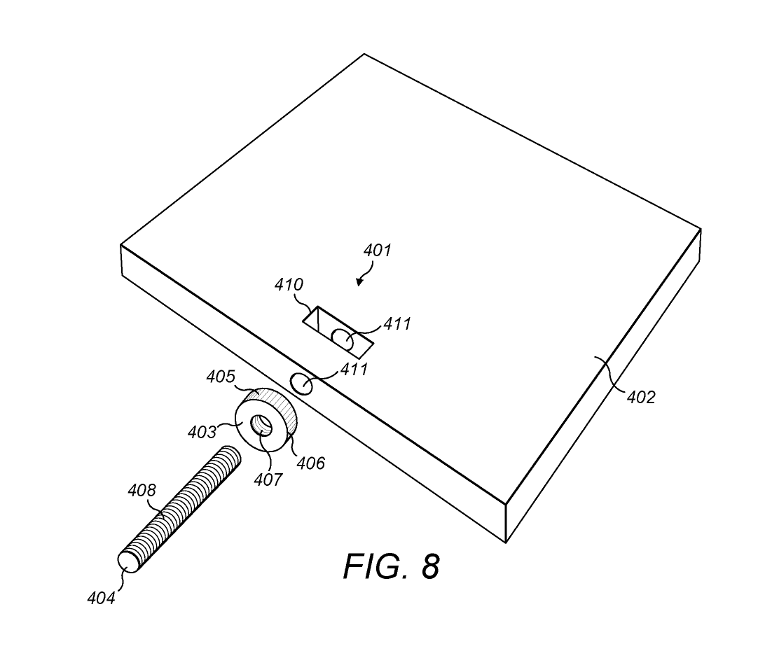

FIG. 8 is a perspective view of the fourth adjustment apparatus in disassembled form; and

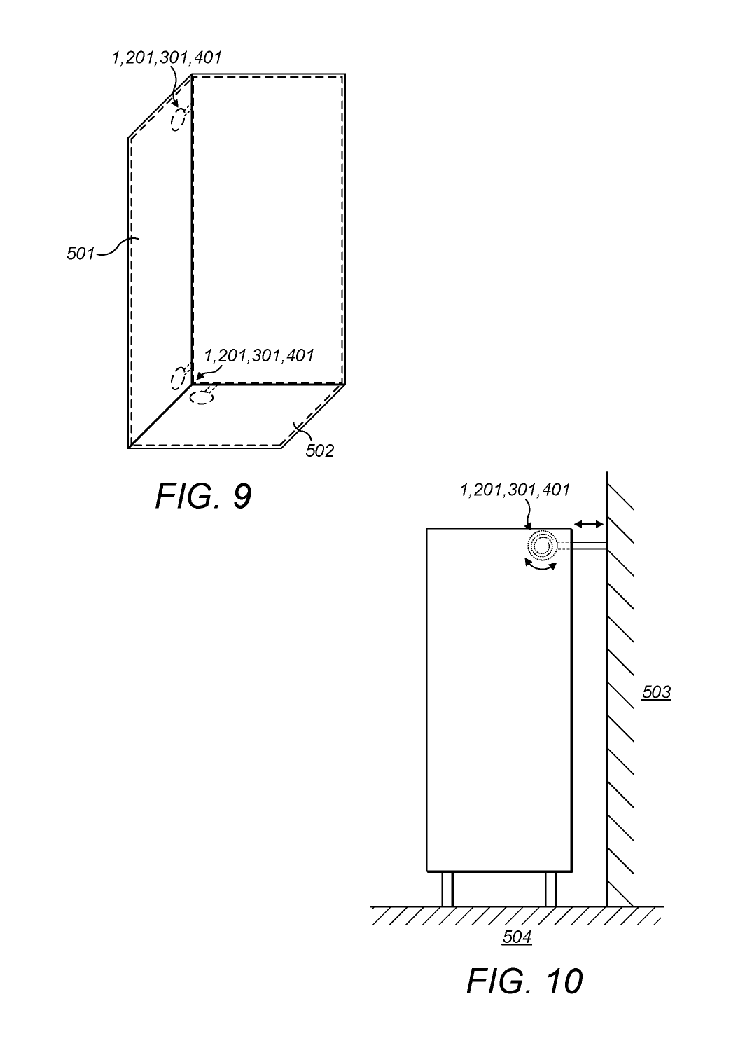

FIG. 9 is a perspective view of an inside of a piece of furniture including an adjustment apparatus;

FIG. 10 is a side elevation of a piece of furniture in situ, including an adjustment apparatus; and

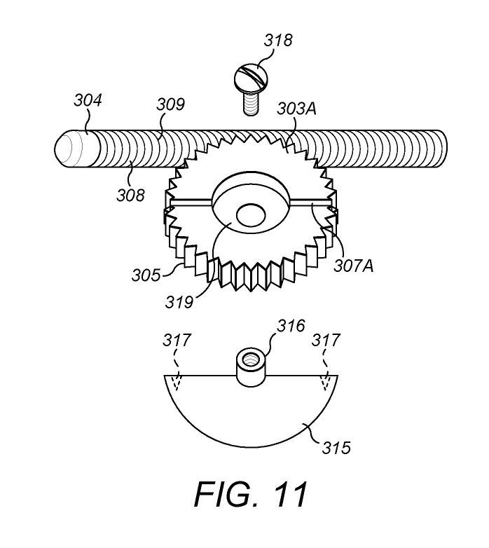

FIG. 11 is an exploded view of an adapted version of the third adjustment apparatus of FIGS. 5 and 6.

FIGS. 1 and 2 show an adjustment apparatus, identified generally by reference 1, which can be placed within an item of furniture 2, preferably within a side wall of an item of furniture. The apparatus includes a first member 3 and a second member 4. The second member 4 is longitudinally movable in use in response to a rotational movement of the first member 3. Axes of movement of the first and second member 3; 4 are perpendicular.

The first member 3 is disc-like having an outer edge region 12, part of which can be received within a circular aperture 5 of the furniture 2. The edge region 12 is received within the aperture 5 such that an outer surface 13 of the disc 3 is flush with an edge of the aperture 5. The outer surface 13 is provided with an aperture for receipt of an Allen® key, although in other arrangements differently-shaped apertures may be used. The disc 3 is rotatable within the aperture 5, and the aperture 5 guides and supports its movement, whilst maintaining contact between the disc 3 and the second member 4. A second side 14 of the disc 3, shown in FIG. 2, includes a spiral-shaped groove 15, the groove 15 being for interaction with the second member 4. The groove 15 is provided by a spiral-shaped walled portion 16—again for interaction with the second member 4—which extends from the surface of the second side 14 and defines the spiral-shaped groove 15. The spiral-groove 15 is a regularly-spaced spiral-groove 15. The groove 15 is open ended, meaning that at both ends there is no stop member, allowing easy entry and exit to/from the groove 15. In particular, at a centre region 17 of the second side 14, there are no obstructions and the walled portion 16 simply ends, without there being a stop, and at an outer region 18, the same occurs. Providing a clear centre region 17 allows the groove 15/walled portion 16 in that central region 17 to easily disengage from the second member 4. The walled portion 16 has approximately two turns.

The second member 4 is a rod having circumferential grooves 19 thereon, which grooves 19 are for interaction with the walled portion 16 of the first member 3. The rod 4 also therefore includes various protrusions 20 which are positioned between respective circumferential grooves 19. The grooves 19 and protrusions 20 are regularly-spaced and extend along most of the length of the rod 4, if not along its entire length. The rod 4 is for receipt within a circular aperture 6 of the furniture 2. The aperture 6 guides and supports its movement, whilst maintaining contact between the rod 4 and disc 3. As shown, the grooves 19 and protrusions 20 provide individual and respective grooves 19 and protrusions 20 unlike a screw thread. An end 21 of the rod 20 may be brought into contact with an upright surface in use. The end 21 may, alternatively, be provided with an extension member (not shown) which increases the effective length of the second member 4. The extension member (not shown) may be connected to the second member 4 using any known connection, for example corresponding screw threads provided on the two members. A part of the second member or extension member may interact with a wall fixing so as to enable securing an item of furniture to the upright surface. In particular, the extension member or the second member 4 may be provided with a screw thread for engaging with a corresponding thread located on a wall fixing so as to enable securing an item of furniture to the upright surface. The rod 4 is, therefore, only at least partly located within the aperture 6 and itself or additional parts must extend from the aperture 6 so as to be contactable with a wall.

In use, the adjustment apparatus 1 is located within a wall of a kitchen cabinet, preferably a side wall 501 or base wall 502 of a kitchen cabinet. To mount the adjustment apparatus 1, unless apertures have already been provided, a larger diameter aperture 5 is provided in an inner-facing panel of the side wall 501, near the upper corner as shown in FIG. 9. This aperture 5 allows the disc 3 to be recessed and flush with the furniture but it is not intended to create a hole right through the furniture. A second smaller diameter aperture 6 is provided at 90 degrees to the first aperture 5, the aperture 6 being formed at an edge of the side panel 501 which faces a rear of the cabinet. The length of this second aperture 6 is typically dimensioned to be shorter than the length of the rod 4. In this example both apertures 5; 6 have a circular cross-section and could be formed by drilling. The disc 3 is inserted into the first aperture 5 and then the rod 4 is inserted into the second aperture 6 such that it abuts the edge region 12 of the disc. Once in contact, the disc 3 is rotated. As the disc 3 rotates, the groove 15 rotates with it and the walled portion 16 at its open end, at the outer region 18, collects one of the protrusions 20 on the rod 4. As the disc 3 is further rotated, the first protrusion travels along the groove 15, towards the centre region 17, and subsequent protrusions are collected by the walled portion 16. Therefore, turning has the effect of causing an interlocking engagement of the disc 3 and the rod 4, whilst allowing adjustment of the relative position of the rod 4 with respect to the furniture 2 or disc 3. In a simplified manner, this is shown in FIG. 10, which shows a kitchen cabinet positioned near an upright surface 503 and stood on a floor 504. As the disc 3 is rotated to adjust the position of the rod 4 within its aperture, a distance and/or orientation of the kitchen cabinet can be adjusted with respect to the upright surface 503.

Preferably, the adjustment apparatus is manufactured from metal and the parts are preferably moulded. However, plastics may also be used or even silicone.

As shown in FIGS. 3 and 4, a second adjustment apparatus, indicated generally by reference 201, is located within a panel 202. A first member 203 is disc-like and is rotatable in use and, as shown in FIG. 3, the disc 3 is counter-sunk into the panel 202 to lie flush with a surface of the panel 202. A second member 204 is a rod, which rod 204 is longitudinally movable in use in response to a rotational movement of the first member 203. Axes of movement of the first and second member 203; 204 are perpendicular.

The disc 203 includes a slot 205 for receipt of a turning device (not shown)—obviously the slot 205 could be differently-shaped to receive different turning devices—on an outer side 206 of the disc 203. An inner side 207 of the disc 203, as shown in FIG. 4, includes a spiral-shaped groove 208 for interacting with the second member 204. The groove 208 is provided as a recess from a surface of the inner side 207. Respective parts of the groove 208 are relatively regularly-spaced, providing for fine adjustment. Further, the groove 208 extends from a centre region 209 of the disc 203 to an outer circumferential edge region 210 of the disc 203 where the groove is open-ended.

The rod 204 is provided with a flattened surface 211, shown as an upper surface 211 in FIG. 4, which surface 211 is adjacent the disc 203 in use. The rod 4 as shown has a rectangular cross-section, however, that is not essential. The flattened surface 211 is provided with a protrusion 212 for interaction with the disc 203. An external-facing end 215 of the second member 204 may be brought into contact with an upright surface in use. The end 215 may, alternatively, be provided with an extension member (not shown) which increases the effective length of the rod 204. The extension member (not shown) may be connected to the rod 204 using any known connection, for example corresponding screw threads provided on the two parts. A part of the rod 204 or extension member may interact with a wall fixing so as to enable securing an item of furniture to the upright surface. In particular, the extension member or the rod 204 could be provided with a screw thread for engaging with a corresponding thread located on a wall fixing so as to enable securing an item of furniture to the upright surface. The rod 204 is, therefore, only at least partly locatable within an aperture and itself or additional parts must extend from the aperture so as to be contactable with an upright surface.

In use, if apertures are not already provided, then two converging apertures are provided in the panel 202 at right angles to each other. A first and larger diameter aperture 213 is provided for receipt of the disc 203 and a second and smaller diameter aperture 214 is provided for receipt of the rod 204. The apertures 213 and 214 guide and support movement of the disc 203 and rod 204, whilst maintaining contact between them. Aperture 213 is shown as having a circular cross-section as this creates the best aperture for receipt of the disc 203 and it is most likely formed by drilling—however, the aperture is not intended to make a hole right through the panel 202. Aperture 214 matches the cross-section of the rod 204—although this is less essential and this aperture could be formed by drilling for convenience. The length of this aperture 214 is typically dimensioned to be shorter than the length of the rod 204. Of course, if drilling is not appropriate, a router could be used. The axes of the apertures 213 and 214 converge, despite being formed at approximately right angles to each other, such that the axis of aperture 214 converges to a centre of the aperture 213. The adjustment apparatus 201 is typically located within a wall of a kitchen cabinet, preferably a side wall 501 or base wall 502 of a kitchen cabinet and further preferably near an upper corner as shown in FIG. 9. In FIGS. 3 and 4 the adjustment apparatus is described in relation to a generic panel 202 which could be, of course, either a side wall 501 or base wall 502 of a kitchen cabinet. The larger aperture 213 is formed in an inner-facing panel of the side wall 501, near the upper corner as shown in FIG. 9, and the smaller aperture 214 is provided at 90 degrees to the first aperture, the aperture 214 being formed at an edge of the side panel 501 which faces a rear of the cabinet. Once the apertures 213; 214 are provided, the rod 204 is slid into its respective aperture 214—most likely gaining access through the larger aperture 213—until the protrusion 212 is located in around a centre of the aperture 213 to correspond with the centre region 209 of the disc 203. Then the disc 203 is placed into its aperture 213, by which action the protrusion 212 of the rod 204 is brought into register with the spiral groove 208 of the disc 203. Rotation of the first member 203 and therefore the spiral groove 208 causes the protrusion 212 to travel along the spiral groove 205 from the centre region 209 towards an edge region 210, which has the effect of advancing the rod in a longitudinal manner along its aperture 214. The external end 215 of the second member 204 can then contact an upright surface (not shown in FIGS. 3 and 4). Therefore, turning has the effect of causing an interlocking engagement of the disc 203 and the rod 204, whilst allowing adjustment of the relative position of the rod 204 with respect to the disc 203. In a simplified manner, this is shown in FIG. 10, which shows a kitchen cabinet positioned near an upright surface 503 and stood on a floor 504. As the disc 203 is rotated to adjust the position of the rod 204 within its aperture, a distance and/or orientation of the kitchen cabinet can be adjusted with respect to the upright surface 503.

In the present example, the disc 3 is plastics and the rod 4 is metal. However, both parts could be either plastics or metal and, preferably, moulded therefrom. Alternatively, silicone could be used for manufacture.

As shown in FIGS. 5 and 6, a third adjustment apparatus, indicated generally by reference 301, is located within a panel 302. A first member 303 is disc-like and is rotatable in use and, as shown in FIG. 5, the disc 303 is counter-sunk into the panel 302 to lie flush with a surface of the panel 302. A second member 304 is a rod, which rod 304 is longitudinally movable in use, in response to a rotational movement of the first member 303. Axes of movement of the first and second member 303; 304 are perpendicular.

The disc 303 includes a slot 307 on an outer-facing side—shown in FIG. 5—for receipt of a turning device (not shown)—obviously the slot 307 could be differently-shaped to receive different turning devices. The disc 303 includes a serrated outer edge 305 for interaction with the rod 304. The serrated edge 305 is provided by regularly-spaced teeth.

The rod 304 is circular in cross-section and is provided with circumferential grooves 308 thereon and, therefore, protrusions 309 between the respective grooves, which grooves 308 and protrusions 309 are for interaction with teeth of the serrated edge 305 of the disc 303. The grooves 308 and protrusions 309 are regularly-spaced and extend along most of the length of the rod 304, if not along its entire length. An end 310 of the rod 304 may be brought into contact with an upright surface in use. A part of the rod 304, typically the end 310, may interact with a wall fixing so as to enable securing an item of furniture to the upright surface. In particular, the rod 304 could be provided with a screw thread for engaging with a corresponding thread located on a wall fixing so as to enable securing an item of furniture to the upright surface. The rod 304 is, therefore, only at least partly locatable within an aperture and itself or additional parts must extend from the aperture so as to be contactable with an upright surface.

This particular arrangement has the advantage that greater adjustment may be provided as movement of the rod 304 is not in any way limited by the position of the adjustment device 301 with respect to a piece of furniture or the diameter of the disc 303. Therefore, the amount of adjustment achievable is only limited by the length of the rod 304.

In use, if apertures are not already provided, then two apertures are provided in the panel 302 at right angles to each other. A first and larger diameter aperture 311 is provided for receipt of the disc 303 and a second and smaller diameter aperture 312 is provided for receipt of the rod 304. The apertures 311 and 312 guide and support movement of the disc 303 and rod 304, whilst maintaining contact between them. The apertures 311 and 312 converge and, at a region 313 in the circumferential surface of the aperture 311, apertures 311 and 312 intersect. In the region 313 the disc 303 and the rod 304 can interact with each other. Aperture 311 is shown as having a circular cross-section as this creates the best aperture for receipt of the disc 303 and it is most likely formed by drilling—however, the aperture is not intended to make a hole right through the panel 302. Aperture 312 matches the cross-section of the rod 304 this aperture could be formed by drilling. The length of this aperture 312 is typically dimensioned to be shorter than the length of the rod 304. Of course, if drilling is not appropriate, a router could be used. The adjustment apparatus 301 is typically located within a wall of a kitchen cabinet, preferably a side wall 501 or base wall 502 of a kitchen cabinet and further preferably near an upper corner as shown in FIG. 9. In FIGS. 5 and 6 the adjustment apparatus is described in relation to a generic panel 302 which could be, of course, either a side wall 501 or base wall 502 of a kitchen cabinet. The larger aperture 311 is formed in an inner-facing panel of the side wall 501, near the upper corner as shown in FIG. 9, and the smaller aperture 312 is provided at 90 degrees to the first aperture, the aperture 312 being formed at an edge of the side panel 501 which faces a rear of the cabinet. Once the apertures 311; 312 are provided, the rod 304 is slid into its respective aperture 312. Then the disc 303 is placed into its aperture 311, by which action disc 303 and the rod 304 are brought into engagement. Alternatively, the disc 303 could be housed first, before the rod 304 is the brought into contact with it, and then the disc 303 could be rotated to draw in the rod 304 further into its aperture 312. Rotation of the first member 303 and therefore the serrated surface 305 has the effect of advancing the rod 304 in a longitudinal manner along its aperture 312. The end 310 of the rod 304 can then contact an upright surface (not shown in FIGS. 5 and 6). Therefore, turning has the effect of causing an interlocking engagement of the disc 303 and the rod 304, whilst allowing adjustment of the relative position of the rod 304 with respect to the disc 303. In a simplified manner, this is shown in FIG. 10, which shows a kitchen cabinet positioned near an upright surface 503 and stood on a floor 504. As the disc 303 is rotated to adjust the position of the rod 304 within its aperture, a distance and/or orientation of the kitchen cabinet can be adjusted with respect to the upright surface 503.

In the present example, the disc 303 is plastics and the rod 304 is metal. However, both parts could be either plastics or metal and, preferably, moulded therefrom. Alternatively, silicone could be used for manufacture.

FIG. 11 shows an exploded view of an adapted version of the adjustment apparatus of FIGS. 5 and 6. Like references have been used to identify common features and, therefore, only the differences will be discussed in detail. This embodiment includes a locking device provided by a plate 315—which includes a spindle 316 and a pair of tabs 317—and a locking screw 318. A disc 303A is an adapted version of the disc 303 of FIGS. 5 and 6 in that it further includes a recessed aperture 319 right through the disc 303A, which aperture 319 is sized to be received upon the spindle 316, about which it may rotate. The spindle 316 is internally treaded so as to receive the locking screw 318. A slot 307A bridges the recessed aperture 319. The plate 315 may be circular or a truncated circle as shown in FIG. 11 and is, approximately, of the same diameter or maximum dimension as the disc 303A (or its aperture 311) and the tabs 317 are small protrusions which extend from under the surface of the plate 315, such that they may engage with a surface of an aperture in a piece of furniture (not shown) into which the plate 315 may be located. Alternatively, the tab 317 or tabs 317 may extend radially to engage the furniture. The locking screw 318 may be screwed into the spindle 316 so as to exert a clamping and/or frictional force upon the disc 303A to prevent its rotation and, for neatness, may be screwed home such that its head is located in a wider part of the recessed aperture 319, beneath the external surface of the disc 303A.

In use, after the aperture 311 is formed for receipt of the disc 303A, the plate 315 is inserted into the aperture 311, where it lies flush with a bottom or distal internal surface of the aperture 311. The tabs 317 engage with the aperture also. The disc 303A is located over the spindle 316, through its aperture 319, and the locking screw 318 is applied, but not overly tightened. The aperture 312 for the rod 304 is preferably formed at the same time as the aperture 311. Once the rod 304 and the disc 303 are brought into contact, the position of the rod 304 with respect to the disc 303 may be adjusted. Once the correct position of rod 304 has been achieved, the screw 318 is screwed home, which provides a clamping/frictional engagement between the plate 315 and the screw 318 on the disc 303A and, as the tabs 317 engage with the aperture of the furniture (not shown), further rotation of the disc 303A is substantially prevented. Naturally, releasing the locking screw 318 makes adjustment possible again.

FIGS. 7 and 8 show a fourth adjustment apparatus, indicated generally by reference 401, which is located within a panel 402. A first member 403 is disc-like and is rotatable in use to cause movement of a second member 404. The second member 404 is a rod, which rod 404 is longitudinally movable in use in response to a rotational movement of the disc 403.

The disc 403 includes a circumferential outer edge 405, for gripping the disc 403 and causing rotation thereof, and an aperture 407 of circular cross-section, which is internally threaded. The aperture 407 is for interaction with the rod 404.

The rod 404 has a circular cross-section and is provided with an externally threaded surface 408 for interaction with the screw thread in the aperture 407. An end 412 of the rod 404 may be brought into contact with an upright surface in use. In particular, the rod 404, typically the end 412, could engage with a corresponding thread located on a wall fixing so as to enable securing an item of furniture to the upright surface. The rod 404 is, therefore, only at least partly locatable within an aperture and itself or additional parts must extend from the aperture so as to be contactable with an upright surface.

This particular arrangement has the advantage that greater adjustment may be provided as movement of the rod 404 is not in any way limited by the position of the adjustment device 401 with respect to a piece of furniture. Therefore, the amount of adjustment achievable is only limited by the length of the rod 404.

In use, if apertures are not already provided, then two apertures are provided in the panel 402 at right angles to each other. A first aperture 410 is provided for receipt of the disc 403 and a second aperture 411 is provided for receipt of the rod 404. The apertures 410 and 411 guide and support movement of the disc 403 and rod 404. However, of course, the disc 403 and rod 404 are threaded together and aperture 410 also functions to constrain longitudinal movement of disc 403 whilst allowing rotational movement thereof. The apertures 410 and 411 converge and intersect such that the disc 403 and the rod 404 can interact in that region. Aperture 410 could be formed by a router and is shown as having a rectangular cross-section. Aperture 411 matches the cross-section of the rod 404—this aperture could be formed by drilling. Of course, if drilling is not appropriate, a router could be used. The adjustment apparatus 401 is typically located within a wall of a kitchen cabinet, preferably a side wall 501 or base wall 502 of a kitchen cabinet and further preferably near an upper corner as shown in FIG. 9. In FIGS. 7 and 8 the adjustment apparatus is described in relation to a generic panel 402 which could be, of course, either a side wall 501 or base wall 502 of a kitchen cabinet. The first aperture 410 is formed in an inner-facing panel of the side wall 501, near the upper corner as shown in FIG. 9, and the second aperture 411 is provided at 90 degrees to the first aperture, the aperture 411 being formed at an edge of the side panel 501 which faces a rear of the cabinet. Once the apertures 410;411 are provided, the rod 404 is slid into its respective aperture 411. Then the disc 403 is placed into its aperture 410, by which action disc 403 and the rod 404 are brought into engagement. Rotation of the disc 403 would then connect the two. Alternatively, the disc 403 could be housed first, before the rod 404 is then brought into contact with it, and then the disc 403 could be rotated to draw in the rod 404 further into its aperture 411. Rotation of the first member 403 and therefore the internal thread in the aperture 407 has the effect of advancing the rod 404 in a longitudinal manner along its aperture 411. The end 412 of the rod 404 can then contact an upright surface (not shown in FIGS. 7 and 8). Therefore, turning has the effect of causing an interlocking engagement of the disc 403 and the rod 404, whilst allowing adjustment of the relative position of the rod 404 with respect to the disc 403. In a simplified manner, this is shown in FIG. 10, which shows a kitchen cabinet positioned near an upright surface 503 and stood on a floor 504. As the disc 403 is rotated to adjust the position of the rod 404, a distance and/or orientation of the kitchen cabinet can be adjusted with respect to the upright surface 503.

In the present example, the disc 403 and the rod 404 are metal. However, both parts could be either plastics or silicone.

FIG. 9 shows alternative or additional locations for an adjustment apparatus 1;201;301;401 within a kitchen cabinet, which apparatus can be located in various positions within the side wall 501, for example in respective upper and/or lower rear corners. If the adjustment apparatus 1;201;301;401 is to be located in a base wall 502, then it could be located in a rear corner of each or either side. Alternatively, but not shown, the adjustment apparatus could be located in a top panel of the kitchen cabinet. Adjustment may be undertaken from inside the cabinet, which has the benefit of being easily achieved even if cabinets are placed adjacent other cabinets or other objects. Adjustment may be undertaken from outside, for example above or beneath the cabinet, so as to keep an inside of the cabinet clear. Further, apertures are not intended to be made all the way through the panel or wall, such that the external appearance of the cabinet is unaltered. Adjustment apparatuses 1;201;301;401 may be included into the furniture at the factory when the cabinets are manufactured, or they may be included when a kitchen is being constructed. Of course, they can be retro fitted too.

Whilst the invention has been described in relation to kitchen cabinets, it is applicable to various types of furniture. The invention may also be used with structural components of buildings, for example a frame, a column, a pillar, a ledge, a lintel, etc.

1. An adjustment apparatus, for providing adjustment of position and/or orientation of a piece of furniture relative to a surface near or against which said piece of furniture is to be placed, wherein the apparatus comprises:
a first member, capable of being rotated; and
a second member, capable of longitudinal movement,
wherein the first and second members are each mountable in said furniture and so guidable in their movement, the first member acts upon the second member to provide longitudinal movement thereof and the second member is arranged to act upon said surface which, in use, is capable of providing adjustment of position and/or orientation of said piece of furniture with respect to said surface.

2. (canceled)

3. An apparatus as claimed in claim 1, wherein the first and second members are arranged to co-operate such that an axis of rotation of the first member is transverse an axis of movement of the second member, or wherein the first and second members are to co-operate such that an axis of rotation of the first member is the same as an axis of movement of the second member.

4. (canceled)

5. (canceled)

6. An apparatus as claimed in claim 1, wherein the first member comprises a spiral-shaped groove and the second member comprises a plurality of protrusions which are capable of interacting with the spiral-shaped groove.

7. (canceled)

8. An apparatus as claimed in claim 6, wherein the spiral-shaped groove and/or the walled portion comprise at least one full rotation.

9. (canceled)

10. (canceled)

11. An apparatus as claimed in claim 1, wherein the first member comprises a spiral-shaped groove and the second member comprises a protrusion which interacts with the groove to move the second member longitudinally.

12. (canceled)

13. An apparatus as claimed in claim 1, wherein the first member comprises a peripheral edge which frictionally engages the second member.

14. An apparatus as claimed in claim 13, wherein the first member comprises one or more teeth for interacting with one or more transverse grooves provided on the second member, or a screw thread provided on the second member.

15. (canceled)

16. (canceled)

17. (canceled)

18. (canceled)

19. An apparatus as claimed in claim 1, the first member comprises an aperture through which the second member can move, wherein the aperture of the first member comprises a screw thread and a surface of the second member comprises a correspondingly-shaped surface.

20. (canceled)

21. (canceled)

22. An apparatus as claimed in claim 1, wherein the second member comprises an extension member.

23. An apparatus as claimed in claim 1, wherein the second member is arranged so as to enable securing the second member to a wall fixing.

24. An apparatus as claimed in claim 1, further comprising a ratchet or locking device engageable with the first member and/or the second member.

25. A piece of furniture comprising an adjustment apparatus, for providing adjustment of position and/or orientation of the furniture relative to a surface near or against which the furniture is to be placed, the apparatus being mounted in an aperture of the furniture, wherein the apparatus comprises:
a first member, capable of being rotated in the aperture; and
a second member, at least part thereof capable of longitudinal movement in the aperture,
wherein the first member acts upon the second member to provide longitudinal movement thereof and the second member is arranged to act upon said surface which, in use, is capable of providing adjustment of position and/or orientation of said piece of furniture with respect to said surface.

26. (canceled)

27. (canceled)

28. A method for assembling a piece of furniture comprising an adjustment apparatus, the method comprising:
providing an aperture in a part of a piece of furniture to which the adjustment apparatus is to be added; and
mounting the adjustment apparatus in the aperture, the adjustment apparatus comprising:
a first member, capable of being rotated in the aperture; and
a second member, at least part thereof capable of longitudinal movement in the aperture,
wherein the first member acts upon the second member to provide longitudinal movement thereof and the second member is arranged to act upon said surface which, in use, is capable of providing adjustment of position and/or orientation of the furniture with respect to said surface.

29. A method as claimed in claim 28, wherein two converging apertures are formed in the furniture.

30. (canceled)

31. (canceled)

32. (canceled)

33. (canceled)

34. (canceled)

35. An apparatus as claimed in claim 22, wherein the second member is arranged so as to enable securing the extension member to a wall fixing.

36. An apparatus as claimed in claim 24, wherein the locking device comprises a flanged spindle for receipt of the first member and locking means for tightening or clamping the first member therebetween.

37. An apparatus as claimed in claim 36, wherein the spindle comprises a tab for contacting said furniture.
